(19) United States
(12) Patent Application Publication
(10) Pub. No.: US 2002/0105682 A1
(43) Pub. Date: Aug. 8, 2002

(54) Image processing apparatus and image processing method

(75) Inventor: Susumu Hakamada, Kawasaki-shi (JP)

Correspondence Address: Johnny A. Kumar, FOLEY & LARDNER, 3000 K Street, N.W., Suite 500, P.O. Box 25696, Washington, DC, 20007-8696, US

(73) Assignee: TOSHIBA TEC KABUSHIKI KAISHA

(21) Appl. No.: 09/775,564

(22) Filed: Feb. 5, 2001

(51) Int. Cl. H04N 1/40

(52) U.S. Cl. 358/461

(57) ABSTRACT

An image processing apparatus and image processing method of the present invention are characterized in that, if a platen cover is opened, image data of a non-original region is erased from data obtained by reading the original, and thereafter density of the image data of the original is sensed and a histogram is made. Thereby, it is possible to avoid the situation wherein a bad influence such as unnatural density variation is caused to an output image.

### BACKGROUND OF THE INVENTION

The present invention relates to an image processing apparatus and image processing method, having a copying function, in particular, having a function of reading density of an original and varying the density of an output image.

In the conventional art, various techniques relating to such an image processing apparatus have been proposed.

FIG. 1 is a block diagram of an image processing apparatus according to the conventional art.

As shown in FIG. 1, a signal which is obtained by taking an image by a CCD 101 is amplified by amplifiers 102 and 104, and thereafter converted to digital signals by A/D converting sections 103 and 105 and inputted in a shading correcting section 106. The signal which has been shading-corrected in the shading correcting section 106 are inputted in a histogram making section 108 to make a histogram. On the basis of the histogram, a density range correcting process section 109 performs density range correcting process.

In the image processing apparatus having such a copying function, no automatic original size sensing function is not added to the function of reading density of an original and varying the density of an output image. Therefore, when a platen cover is opened, a non-original region is also determined to be image data, which have a bad influence on the output image, such as unnatural density variation.

In view of such a point, the following techniques have been disclosed in the conventional art.

Specifically, Jpn. Pat. Appln. KOKAI Pub. No. 6-276368 discloses a technique wherein opening of a platen cover is sensed, and data of a region outside the original is erased in the read image data.

Further, Jpn. Pat. Appln. KOKAI Pub. No. 10-224635 discloses an technique wherein the kind of the original is decided, even in the state of opening a platen cover, on the basis of the difference in density between an original region and a non-original region to set an optimum density conversion parameter. Jpn. Pat. Appln. KOKAI Pub. No. 08-242358 discloses a technique wherein an unnecessary region which is not to be copied is determined from the image region, the unnecessary region is removed and controlled, and thereafter image processing such as density control is performed.

However, in the technique disclosed in Jpn. Pat. Appln. KOKAI Pub. No. 6-276368, since a region outside the original is erased after density processing, the density including the value of the density in the region unrelated to the original is calculated to determine the density setting value, and therefore good density processing cannot be performed.

Further, in the technique disclosed in Jpn. Pat. Appln. KOKAI Pub. No. 10-224635, since the region outside the original and the region within the original are determined to set a predetermined density setting value, the accuracy of the density setting value is lower than that of a density setting value determined by calculation or the like.

Furthermore, the technique disclosed in Jpn. Pat. Appln. KOKAI Pub. No. 08-242358 has no disclosure concerning the difference in control depending on opening/closing a platen cover of a machine having no original size sensing function (the non-original region is erased only when the platen cover is opened).

### BRIEF SUMMARY OF THE INVENTION

The object of the present invention is to provide an image processing apparatus and image processing method, wherein unnatural density variation, which occurs when opening the platen cover 10, is removed in an image processing apparatus having a copying function including no original size sensing function, even if a function of reading the density of the original and varying the density of the image thereafter is used.

In order to achieve the above object, an image processing apparatus according to a first embodiment of the present invention comprises: a CCD for taking an image of an original and converting the image to an electrical signal; an A/D converting section for converting the electrical signal to a digital signal; a shading correcting section for performing shading correction for the digital signal; a non-original region erasing process section for erasing image data relating to a region outside the original from the shading-corrected digital signal; a histogram making section for making a histogram on the basis of the data after erasing; and a density range correcting process section for performing density range correction based on the histogram.

An image processing method according to a second embodiment comprises: a first step of taking an image of an original and converting the image to an electrical signal; a second step of converting the electrical signal to a digital signal; a third step of performing shading correction for the digital signal; a fourth step of erasing image data relating to a region outside the original from the shading-corrected digital signal; a fifth step of making a histogram based on the data after erasing; and a sixth step of performing density range correction based on the histogram.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a structure of an image processing apparatus according to the conventional art,

FIG. 2 is a block diagram showing a structure of an image processing apparatus according to an embodiment of the present invention,

FIG. 3 is an outside drawing of the image processing apparatus according to the embodiment of the present invention, and

FIG. 4 is a flow chart showing operation of the image processing apparatus according to the embodiment of the present invention.

### DETAILED DESCRIPTION OF THE INVENTION

The image processing apparatus and the image processing method of the present invention are characterized in that, if a platen cover is opened, image data of a non-original region is erased from data obtained by reading the original, and thereafter density of the image data of the original is sensed and a histogram is made.

If this function is used, when copying is performed with the platen cover opened, the apparatus does not determine a non-original region to be image data, which can avoid the situation wherein a bad influence such as unnatural density variation is caused to an output image.

Based on the above, an embodiment of the present invention will now be described.

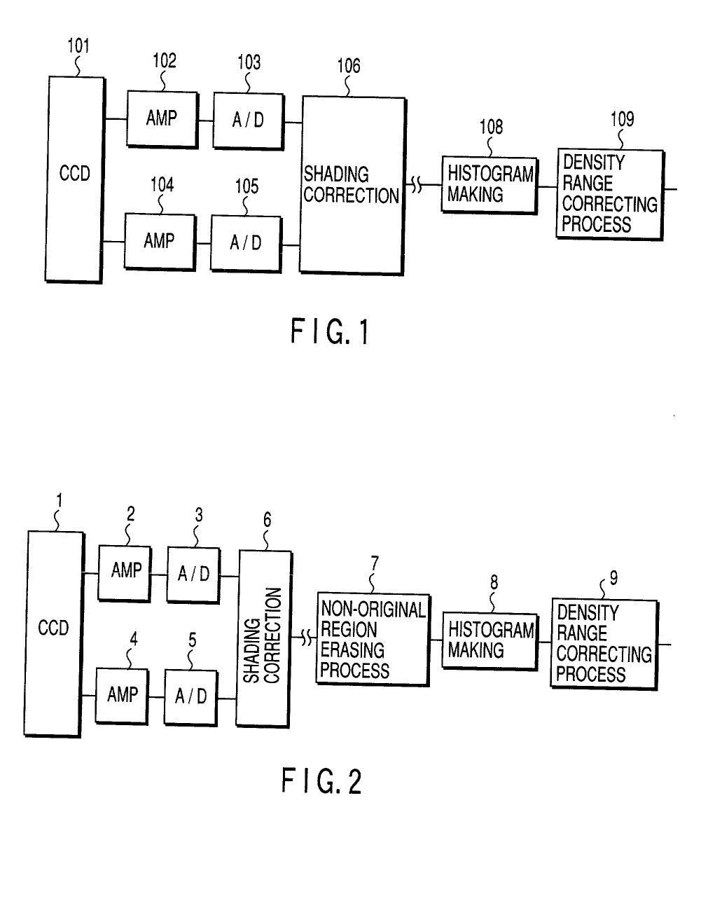

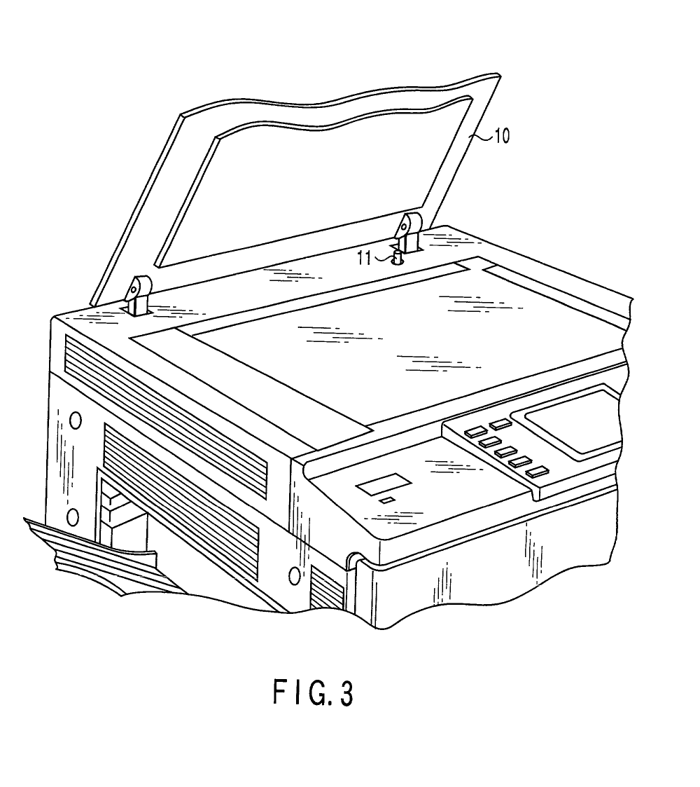

FIG. 2 is a block diagram showing a structure of an image processing apparatus according to an embodiment of the present invention. FIG. 3 is an outside drawing of the image processing apparatus.

The present invention is different from the conventional art (FIG. 1) described above, in that a non-original region erasing process section 7 is added, as an image editing function, to a preceding stage of the histogram making section 8. The other parts of the structure of the apparatus are the same as that in FIG. 1.

As shown in FIG. 2, a signal which has been obtained by taking an image in a CCD 1 is amplified by amplifiers 2 and 4, thereafter converted to a digital signal by A/D converting sections 3 and 5 and inputted in a shading correcting section 6. The signal which has been shading-corrected in the shading correcting section 6 is inputted in the non-original region erasing process section 7.

The non-original region erasing process section 7 erases image data of a region outside the original, even if a platen cover 10 is opened, for example. The image data after erasing the region outside the original is inputted in the histogram making section 8, which makes a predetermined histogram based on the image data. On the basis of the histogram made in such a manner, a density range correcting process section 9 performs density range correcting process. Further, “a predetermined switch” recited in the claims indicates a switch such as a platen cover opening/closing detecting switch 11 shown in FIG. 2.

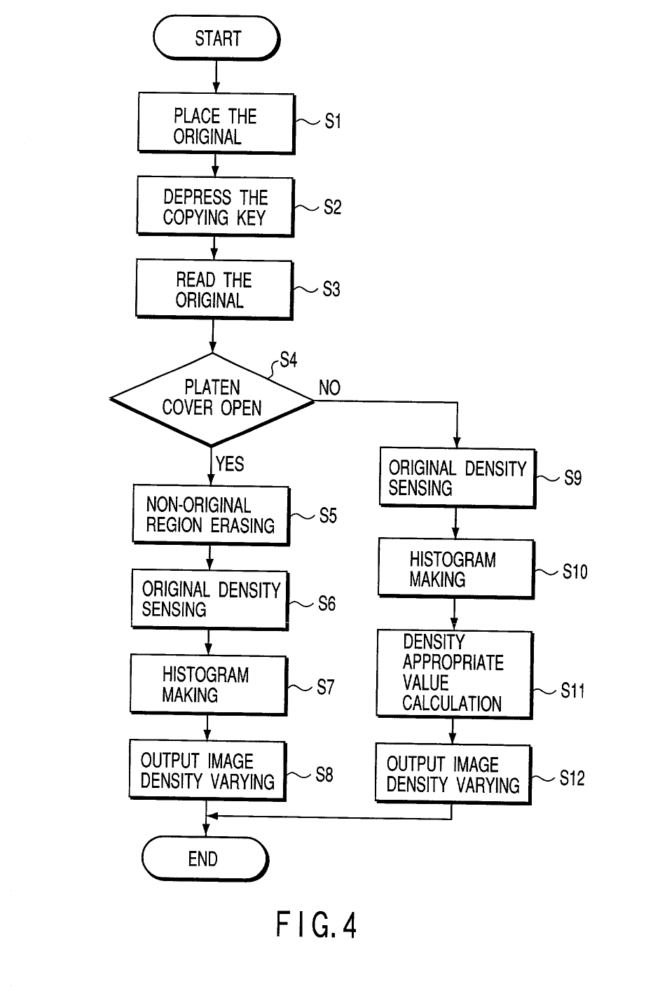

The operation of the image processing apparatus according to the embodiment will now be described in more detail, with reference to the flow chart of FIG. 4.

Further, the operation corresponds to the image forming method of the present invention.

In the image processing apparatus of the embodiment, after the CCD 1 reads the original in response to depressing of a copying key (not shown), the following process is changed according to the opening/closing state of the platen cover 10 (steps S1 to S4).

Specifically, if the platen cover 10 is opened (if the answer of the step S4 is YES), the image data of a non-original region is black. If an appropriate density is calculated in the state of including the image data, unnatural density variation occurs in an output image.

In order to overcome such defect, in this image processing apparatus, the non-original region erasing process section 7 performs the non-original region erasing processing (step S5). Thereafter, the density of the original is sensed (step S6), the histogram making section 8 makes a histogram (step S7), and the density range correcting process section 9 calculates an appropriate density to vary the density of an output image (step S8). Then, the operation is finished.

In the meantime, if the platen cover 10 is closed (if the answer of step S4 is NO), since it is enough to only determine a back surface of the platen cover 10 to be image data, the following process is performed. Specifically, the density of the original is sensed without any process (step S9), the histogram making section 8 makes a histogram (step S10), and the density range correcting process section 9 calculates an appropriate density (step S11) and varies the density of an output image (step S12). Then, the operation is finished.

Further, the opening/closing state of the platen cover 10 is detected by the platen cover opening/closing detecting switch 11, for example.

As described above, in the image processing apparatus and the image processing method of the present invention, the erasing of a non-original region is performed prior to the density processing. Further, an non-original region and an original region are distinguished and determined, and the density setting value or the like is determined by calculation. Specifically, data of a region irrelevant to the original is removed, and then the density is calculated to determine the density setting value.

Therefore, the present invention produces an effect that unnatural density variation, which occurs when opening the platen cover 10, is removed in an image processing apparatus having a copying function including no original size sensing function, even if a function of reading the density of the original and varying the density of the image thereafter is used.

Additional advantages and modifications will readily occur to those skilled in the art. Therefore, the invention in its broader aspects is not limited to the specific details and representative embodiments shown and described therein. Accordingly, various modifications may be made without departing from the spirit or scope of the general inventive concept as defined by the appended claims and their equivalents.

What is claimed is:

1. An image processing apparatus comprising:
a CCD for taking an image of an original and converting the image to an electrical signal;
an A/D converting section for converting the electrical signal to a digital signal;
a shading correcting section for performing shading correction for the digital signal;
a non-original region erasing process section for erasing image data relating to a region outside the original from the shading-corrected digital signal;
a histogram making section for making a histogram on the basis of the data after erasing; and
a density range correcting process section for performing density range correction based on the histogram.

2. An image processing apparatus according to claim 1, wherein the non-original region erasing process section erases the image data relating to the region outside the original from the shading-corrected digital signal, only when a platen cover is opened.

3. An image processing apparatus according to claim 1, wherein the non-original region erasing process section performs the erasing before processing by the histogram making section and the density range correcting process section.

4. An image processing apparatus according to claim 1, wherein the non-original region erasing section erases the image data relating to the region outside the original from the shading-corrected digital signal, if erasing of the region outside the original is instructed by a predetermined switch.

5. An image processing apparatus of claim 4, wherein the predetermined switch interlocks with opening/closing of the platen cover.

6. An image processing apparatus according to claim 1, wherein if the platen cover is opened, the non-original region erasing process section performs non-original region erasing process, the histogram making section makes a histogram, and the density range correcting process section calculates an appropriate density to vary a density of an output image, and
if the platen cover is closed, the histogram making section makes a histogram, and the density range correcting process section calculates an appropriate density to vary the density of the output image.

7. An image processing method comprising:
a first step of taking an image of an original and converting the image to an electrical signal;
a second step of converting the electrical signal to a digital signal;
a third step of performing shading correction for the digital signal;
a fourth step of erasing image data relating to a region outside the original from the shading-corrected digital signal;
a fifth step of making a histogram based on the data after erasing; and
a sixth step of performing density range correction based on the histogram.

8. An image processing method according to claim 7, wherein the fourth step erases the image data relating to the region outside the original from the shading-corrected digital signal, only when a platen cover is opened.

9. An image processing method according to claim 7, wherein the fourth step erases the image data relating to the region outside the original from the shading-corrected digital signal, if erasing of the region outside the original is instructed by a predetermined switch.

10. An image processing method according to claim 7, wherein the predetermined switch interlocks with opening/closing of the platen cover.
